(19) United States
(12) Patent Application Publication
(10) Pub. No.: US 2007/0136446 A1
(43) Pub. Date: Jun. 14, 2007

(54) Wireless media server system and method

(76) Inventors: Behrooz Rezvani, San Ramon, CA (US); Andrea Goldsmith, Menlo Park, CA (US)

Correspondence Address: PERKINS COIE LLP, P.O. BOX 2168, MENLO PARK, CA, 94026, US

(21) Appl. No.: 11/607,815

(22) Filed: Dec. 1, 2006

Related U.S. Application Data
(60) Provisional application No. 60/741,672, filed on Dec. 1, 2005.

(51) Int. Cl. G06F 15/16

(52) U.S. Cl. 709/219

(57) ABSTRACT

Portable media devices allow a user to access music or other media stored on the device, and two portable media devices equipped with wireless technology can exchange stored files over the air.

### BACKGROUND

Point-to-multipoint communication systems provide communications between a central device and multiple remote devices. Communications may be directed at a specific remote device or to all/some devices simultaneously. Wireless music centers store audio files and stream them wirelessly to multiple independent stations, but these devices are not portable.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for providing content to wireless portable media (WPM) clients involves creating a wireless link between the WPM clients and a WPM server. The WPM server may receive content from a content provider over a wireless or wired link. Once the content is uploaded to the WPM server, the WPM server can provide the content wirelessly to the WPM clients. Advantageously, since the WPM server and the WPM client are both mobile, the system can be used in a variety of locations, such as, by way of example but not limitation, in a car, or at an impromptu party where media is shared between the WPM clients.

### BRIEF DESCRIPTION OF THE DRAWINGS

Embodiments of the inventions are illustrated in the figures. However, the embodiments and figures are illustrative rather than limiting; they provide examples of the invention.

FIG. 1 depicts an example of a system that includes a wireless content server.

FIG. 2 depicts an example of a system including a WPM server and a plurality of WPM clients.

FIG. 3 depicts a flowchart of an example of a method for providing content from a WPM server to a WPM client.

FIG. 4 depicts an example of a system for providing music from a WPM server to a single WPM client.

FIG. 5 depicts an example of a system for providing music from a WPM server to multiple WPM clients.

FIG. 6 depicts a flowchart of an example of a method for music sharing in a WPM environment.

FIG. 7 depicts an example of a system that includes various WPM clients in a WPM environment.

FIG. 8 depicts an example of a portable speaker system in a WPM environment.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

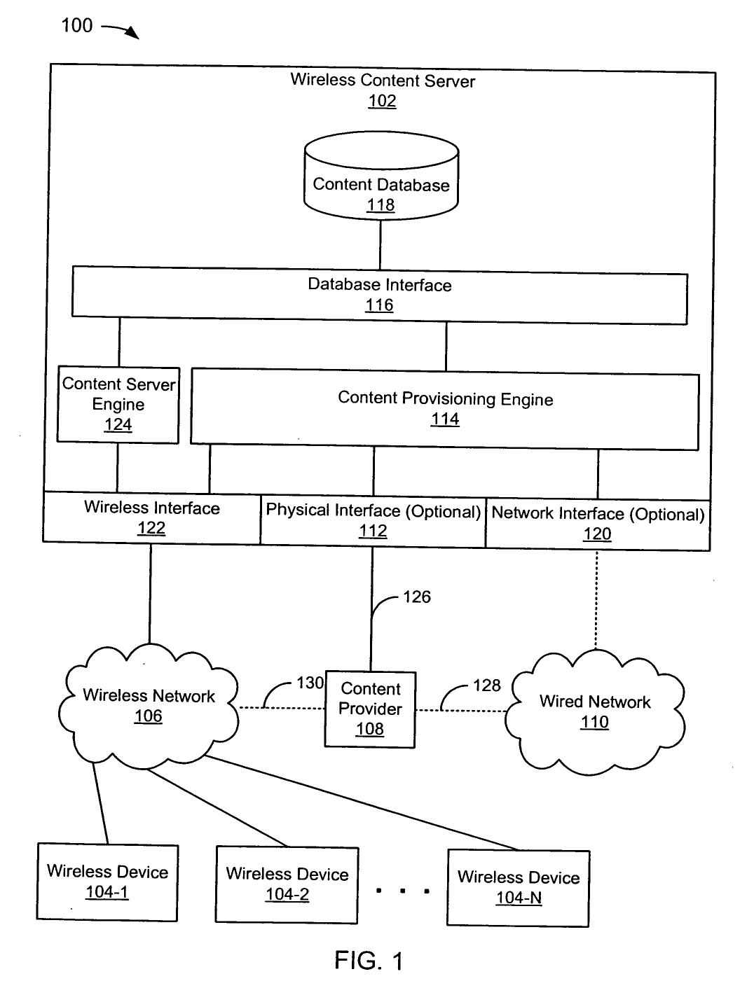

FIG. 1 depicts an example of a system 100 that includes a wireless content server. In the example of FIG. 1, the system 100 includes a wireless content server 102, wireless devices 104-1 to 104-N (referred to collectively as wireless devices 104), a wireless network 106, a content provider 108, and a wired network 110.

The wireless content server 102 may be implemented on any of many possible computer systems having different architectures. For example, personal computers based on an Intel microprocessor often have multiple buses, one of which can be an I/O bus for peripherals and one that directly connects processor and memory (often referred to as a memory bus). The buses are connected together through bridge components that perform any necessary translation due to differing bus protocols. Network computers are another type of computer system that can be used. Network computers do not usually include a hard disk or other mass storage, and the executable programs are loaded from a network connection into memory. A Web TV system, which is known in the art, is also considered to be a computer system, but it may lack some of the features typical with personal computers, such as certain input or output devices.

An apparatus for performing techniques described herein may be specially constructed for the required purposes, or it may comprise a general purpose computer selectively activated or reconfigured by a computer program stored in the computer. Such a computer program may be stored in a computer readable storage medium, such as, by way of example but not limitation, read-only memories (ROMs), RAMs, EPROMs, EEPROMs, magnetic or optical cards, any type of disk including floppy disks, optical disks, CD-ROMs, DVDs, and magnetic-optical disks, or any known or convenient type of media suitable for storing electronic instructions.

The wireless content server 102 includes an optional physical interface 112, a content provisioning engine 114, a database interface 116, a content database 118, an optional network interface 120, a wireless interface 122, and a content server engine 124. The optional physical interface 112 may include any port to which a device may be directly connected to the wireless content server 102 (such as, by way of example but not limitation, a USB port, though any applicable known or convenient interface could be used).

The content provisioning engine 114 includes a processor (such as, by way of example but not limitation, a microprocessor, though any applicable known or convenient processor could be used), whether dedicated or shared, and a computer-readable medium having programs stored thereon. The computer-readable medium may include memory, which may be referred to as primary memory (including, by way of example but not limitation, dynamic random access memory (DRAM) or static RAM (SRAM), though any applicable known or convenient memory could be used) or secondary memory (including, by way of example but not limitation, a magnetic hard disk or an optical disk, though any applicable known or convenient memory could be used). Data stored in secondary memory is typically written to primary memory during execution of the programs embodied in the computer-readable medium. The computer-readable medium encompasses a carrier wave that encodes a data signal.

The wireless content server 102 may be controlled by an operating system (OS). An OS is a software program—used on most, but not all, computer systems—that manages the hardware and software resources of a computer. Typically, the OS performs basic tasks such as controlling and allocating memory, prioritizing system requests, controlling input and output devices, facilitating networking, and managing files. Examples of operating systems for personal computers include Microsoft Windows®, Linux, Mac OS®, or ARM® (the latter being popular in embedded systems). Delineating between the OS and application software is sometimes rather difficult. Fortunately, delineation is not necessary to understand the techniques described herein, since any reasonable delineation should suffice.

The wireless content server 102 will, in typical implementations, include I/O devices (such as, by way of example but not limitation, a keyboard, a disk drive, a printer, a scanner, a mouse, or buttons, switches, wheels, or dials). A display controller may control, in a known or convenient manner, a display (such as, by way of example but not limitation, a cathode ray tube (CRT) or liquid crystal display (LCD)). The display controller and/or other I/O controllers may include device drivers. A device driver is a specific type of computer software developed to allow interaction with hardware devices. Typically this constitutes an interface for communicating with the device, through a bus or communications subsystem that the hardware is connected to, providing commands to and/or receiving data from the device, and on the other end, the requisite interfaces to the OS and software applications.

The wireless devices 104 may include any device capable of receiving and using content from the wireless content server 102. Such devices may include wireless headsets, handsets (such as, by way of example but not limitation, PDAs, cell phones, and the like), speakers, projectors, etc.

The wireless network 106 may include one or more wireless access points that are capable of receiving wireless signals from the wireless content server 102 and the wireless devices 104 and transmitting the wireless signals to the wireless content server 102 and the wireless devices 104. In this way, the wireless content server 102 and the wireless devices 104 are wirelessly connected to one another. In an embodiment, the wireless content server 102 could include an access point to which the wireless devices 104 connect (thereby obviating the need for a separate wireless network 106). However, primarily for illustrative simplicity, it is assumed that a wireless network actually exists as distinct from the wireless content server 102, as shown in the example of FIG. 1. It should be noted that one or more of the wireless devices 104 could incorporate an access point, in a manner similar to that just described with respect to the wireless content server 102. The wireless network 106 may or may not be connected to a wired network.

The content provider 108 may be any known or convenient device that is capable of providing content to the wireless content server 102. In an embodiment, the content provider 108 could include one or more of the wireless devices 104. There are many ways through which the content provider 108 provides content to the wireless content server 102, a few of which are described later where the system 100 is described “in operation.” There are also many paths through which the content provider 108 could provide content to the wireless content server, which are generalized to the paths 126, 128, and 130 in the example of FIG. 1, each of which is described later where the system 100 is described “in operation.”

The means by which the content provider 108 is stimulated to provide content is not critical. Some examples include a request by the wireless content server 102, a request by one of the wireless devices 104 (possibly indirectly through the wireless content server 102), a request received through email, instant messaging, or some other messaging protocol from a device (not shown), in accordance with a schedule at the content provider 108, as designated by an administrator (whether human or artificial), or some other convenient means. The number of ways that the content provider 108 could be stimulated to provide content is nearly innumerable so no attempt is made to provide all cases.

Although the wired network 110 is not a critical component of the system 100, it will exist in any embodiment, even if not used, because the wired network 110 is intended to include the Internet. However, in a particular embodiment, the wired network 110 could include a WAN, LAN, or some other public, semi-public, private, ad hoc, or stand-alone (e.g., uncoupled to the Internet) network. The wired network 110 may include one or more wireless networks that are connected at some point to a wired backbone.

In operation, (according to a first content provisioning embodiment) the content provider 108 sends content to the wireless content server 102 via the path 126 to the physical interface 112. The physical interface 112 is intended to include any applicable known or convenient port through which a device can be directly coupled to the wireless content server. The connection of the device to the physical interface 112 is intended to include indirect connections, so long as the device is relatively local, and is wire connected (since if the device is wirelessly connected, the device would be connected via the wireless interface 122).

The content provisioning engine 114 controls how content received on the physical interface 112 is to be handled. In a simple case, the content provisioning engine 114 transmits, forwards, or allows through content to the database interface 116, which stores the content in the content database 118. Content may include audio files, multimedia files, software applications, or any other content that is capable of playback at one or more of the wireless devices 104.

If the content database 118 is full, it may be required for the content provisioning engine 114 to decide what to do. For example, the content provisioning engine 114 may replace the oldest content with the content received on the physical interface 112. Alternatively, the content provisioning engine 114 may replace content that has been accessed least recently with the content received on the physical interface 112. Alternatively, the content provisioning engine 114 may replace random content with the content received on the physical interface 112. In another embodiment, a portion of the content database 118 may be a shared library, while another portion may be allocated between users.

Content could also have a priority value assigned to it upon receipt, and the content provisioning engine 114 may replace lower priority content with higher priority content. In such an alternative, it may be possible that new content would not even be written to the content database 118, if it is lower priority than all of the content that currently fills up the content database 118.

A user associated with content may also effect the determination by the content provisioning engine 114 regarding whether to replace older content with new content. For example, the content database 118 may be segmented to allow storage of content by users associated with one or more of the wireless devices 104. If a first user associated with the wireless device 104-1 fills up the content database 118 through requests to the content provider 108, a second user associated with the wireless device 104-2 may request new content that overwrites content of the first user. The first user would not then be able to overwrite the second user's requested content with a later request, even if the second user's requested content is older. This may be referred to as dynamic allocation of storage by user, since users can have more than their share of content if other users do not utilize their full share. Alternatively, the content database 118 could be statically apportioned by user such that a first user cannot fill up more than an allocated portion of the content database 118, even if a second user does not use up his or her allocated portion.

In operation, (according to a second content provisioning embodiment) the content provider 108 sends content to the wireless content server 102 via the path 128 to the network interface 120. The network interface 120 is intended to include any applicable known or convenient port through which a device can be coupled to the wireless content server through a wired network. For example, the network interface 120 may be coupled to a modem (such as, by way of example but not limitation, an analog modem, an ISDN modem, or a cable modem). The network interface 120 may also include a token ring interface, satellite transmission interface (e.g., “direct PC”), AM/FM/XM receiver, or some other known or convenient interface for coupling one computer system to other computer systems accessible through a wired network.

The content provider 108, in this content provisioning embodiment, sends content through the wired network 110 via the path 128. (The path 128 is represented as a dotted line because it is an alternative to the path 126, described previously). It may be noted that the path 126 (and the physical interface 112) and the path 128 (and the network interface 120) may be implemented together or in the alternative. Upon receipt at the network interface 120, content is treated similarly to that described with respect to the first content provisioning embodiment.

In operation, (according to a third content provisioning embodiment) the content provider 108 sends content to the wireless content server 102 via the path 130 to the wireless interface 122. The wireless interface 122 is intended to include any applicable known or convenient port through which a device can be coupled to the wireless content server through a wireless network. For example, the wireless interface 122 may be associated with any known or convenient wireless protocol (such as, by way of example but not limitation, IEEE 802.11a/b/g/n, IEEE 802.15 (Bluetooth/UWB/Zigbee), or a proprietary wireless protocol).

The content provider 108, in this content provisioning embodiment, sends content through the wireless network 106 via the path 130. (The path 130 is represented as a dotted line because it is an alternative to the path 126, described previously). It may be noted that the path 126 (and the physical interface 112) and the path 130 (and the wireless interface 122) may be implemented together or in the alternative. Upon receipt at the wireless interface 122, content is treated similarly to that described with respect to the first content provisioning embodiment.

It should be noted that in an embodiment in which the content provider 108 uses path 130, the content provider 108 may actually be included in the devices 104. However, for illustrative purposes, the content provider 108 is treated as distinct from the wireless devices 104 when describing instances where content is provided to the wireless interface 122 (concordantly, the wireless devices 104 are treated as distinct from the content provider 108 when content is received from the wireless interface 122). Thus, where content is transceived (e.g., the wireless devices 104 are capable of both sending and receiving content) the content provider 108 may not be needed as a distinct component (though it still could exist, in certain implementations, as a device that does not play content, but can provide it).

In operation, regardless of the content provisioning embodiment used, the wireless devices 104 receive content from the wireless content server 102. The wireless devices 104 may request content (or the request may be generated internally at the content server engine 124, or the request may be received from some other device (not shown)). A request for content from the wireless devices 104 is received at the wireless interface 122, and the content server engine 124 determines how to respond. The content server engine 124 will access the content database 118 through the database interface 116 to obtain the requested content, and transmit, forward, or pass through the content to the wireless interface 122 for transmission to the appropriate wireless device(s) 104. The content server engine 124 may request additional information (e.g., narrow the search, provide an intended list of recipients, etc.) in the course of determining the appropriate content to serve.

As used herein, algorithmic descriptions within a computer memory are believed to most effectively convey the techniques to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer architecture. The techniques may be implemented using any known or convenient programming language, whether high level (e.g., C/C++) or low level (e.g., assembly language), and whether interpreted (e.g., Perl), compiled (e.g., C/C++), or Just-In-Time (JIT) compiled from bytecode (e.g., Java). Any known or convenient computer, regardless of architecture, should be capable of executing machine code compiled or otherwise assembled from any language into machine code that is compatible with the computer's architecture, including that of embedded systems, if applicable.

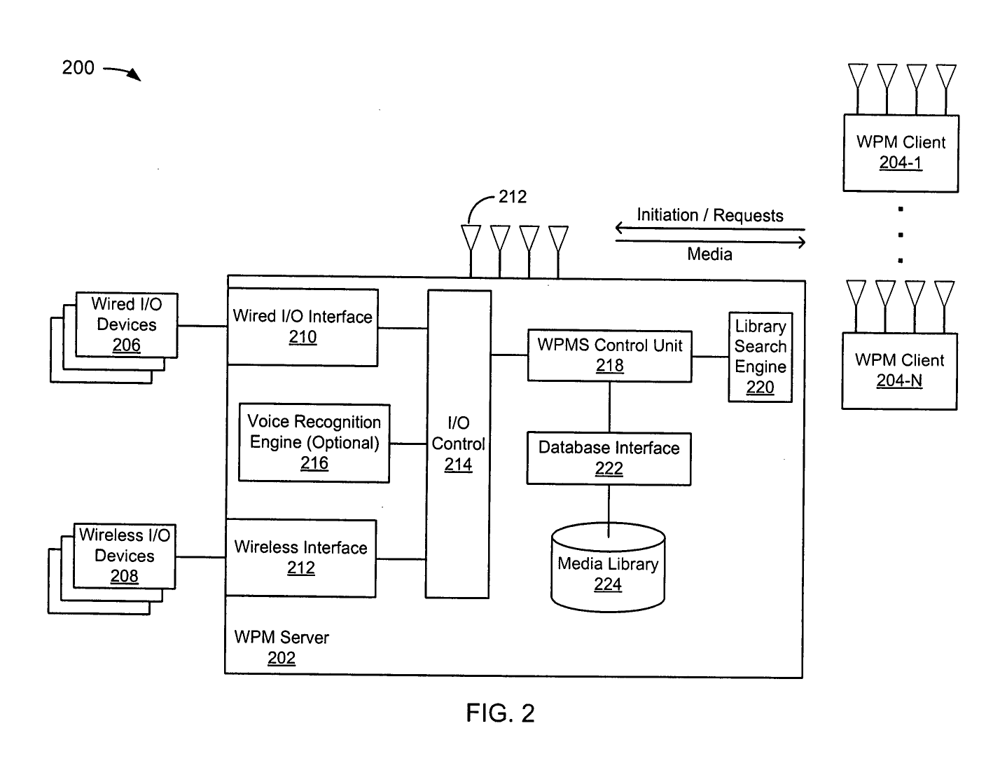

FIG. 2 depicts an example of a system 200 including a wireless portable media (WPM) server and a plurality of WPM clients. In the example of FIG. 2, the system 200 includes a WPM server 202, WPM clients 204-1 to 204-N (referred to collectively as the WPM clients 204), wired I/O devices 206, and wireless I/O devices 208. In the example of FIG. 2, the WPM server 202 includes a wired I/O. interface 210, a wireless interface 212, I/O control 214, an optional voice recognition engine 216, a WPM Server (WPMS) control unit 218, a library search engine 220, a database interface 222, and a media library 224. Advantageously, the WPM server 202 can be mounted practically anywhere, such as in an automobile, on a worn article, or some other mobile or small thing.

The WPM clients 204 are any portable devices that are capable of wirelessly receiving media from the WPM server 202 for playback. For audio media, this will typically include some type of speaker system (e.g., headphones or portable speakers). For video, this will typically include some type of display (e.g., an LCD or a projector). For multi-media, of course, this will typically include both a speaker system and a display.

The wired I/O devices 206 may include any applicable known or convenient I/O device (such as, by way of example but not limitation, buttons, keyboard, or microphone). The wireless I/O devices 208 may include many of the same types of devices that can be wire connected (e.g., wireless keyboards or microphones), but further include remote controls, which are by definition wireless. It may be noted that the WPM clients 204 may be thought of as wireless I/O devices. However, the WPM clients 204 may be distinguishable in that they are recipients of media for playback. The WPM clients 204 may be further distinguishable from the wireless I/O devices 208 if they use, for example, a different protocol and/or a different wireless interface at the WPM server 202.

In the example of FIG. 2, in operation, the WPM server 202 receives input on the wired I/O interface 210 and/or the wireless interface 212. The input may include commands that are used by the WPMS control unit 218 to change parameters, effect media storage, or accomplish some other task. The input is received at the I/O control 214 and converted (if necessary) to a format usable by the WPMS control unit 218. For example, if the input is in the form of voice, the I/O control 214 may make use of the voice recognition engine 216 to convert the voice commands to an appropriate format. The I/O control 214 provides the commands and/or data associated with the input to the WPMS control unit 218.

The input may be used to change characteristics of the WPMS control unit 218, search parameters or other characteristics of the library search engine 220, or to store media in the media library 224 (via the database interface 222). For example, the input may include a command to dynamically or statically apportion the media library 224 such that storage resources are split between users associated with one or more of the WPM clients 204. As another example, the data could include media that is to be stored in the media library 224.

In the example of FIG. 2, in operation, the WPM clients 204 attempt to wirelessly connect (initiation) to the WPM server 202. The wireless connection may be formed in any applicable known or convenient manner.

Once a wireless connection is established, the WPM clients 204 make requests for media from the WPM server 202. The requests are received at the wireless interface 212 (which may or may not be a different wireless interface from that on which input from the wireless I/O devices 208 are received). The I/O control 214 provides the input to the WPMS control unit 218. The input may include a request for media content, in which case the WPMS control unit 218 uses the library search engine 220 to find the media in the media library 224. The input may include a list of intended recipients for media (which may be included in a single request or sent separately).

In response to a request, the WPM control unit 218 transmits, forwards, or allows through to the appropriate WPM client(s) 204 media found in the media library 224 in accordance with search criteria provided in the input to the library search engine 220. Search criteria may be found in inputs from the WPM clients 204, generated in the WPMS control unit, and/or generated in the library search engine 220 using instructions provided by the WPMS control unit. Search criteria may include, in an example where the media is music, song title, album name, artist name, keywords, lyrics, a hummed tune (input, for example, via a microphone), popularity, similarity to other music, genre, etc.

The storage capacity for the media library 224 will depend on the memory capabilities of the WPM server 202. For example, a typical flash memory may store 10-20 songs, depending on the music compression technique. The media library 224 may also store media files for a single content request (e.g., a song) of different sizes based on different compression schemes. When a media file is requested, the media file's size to transmit to the requesting device may be selected based on the available bandwidth in the system for that transmission, which will depend on the propagation environment, the number of other users accessing the system, and the amount of interference in the wireless signal bandwidth. The media library 224 may be created by one or more users, and may be partitioned such that each user has their own individual library (which can be made accessible to all/some other users) and/or there is a shared library accessible by all users.

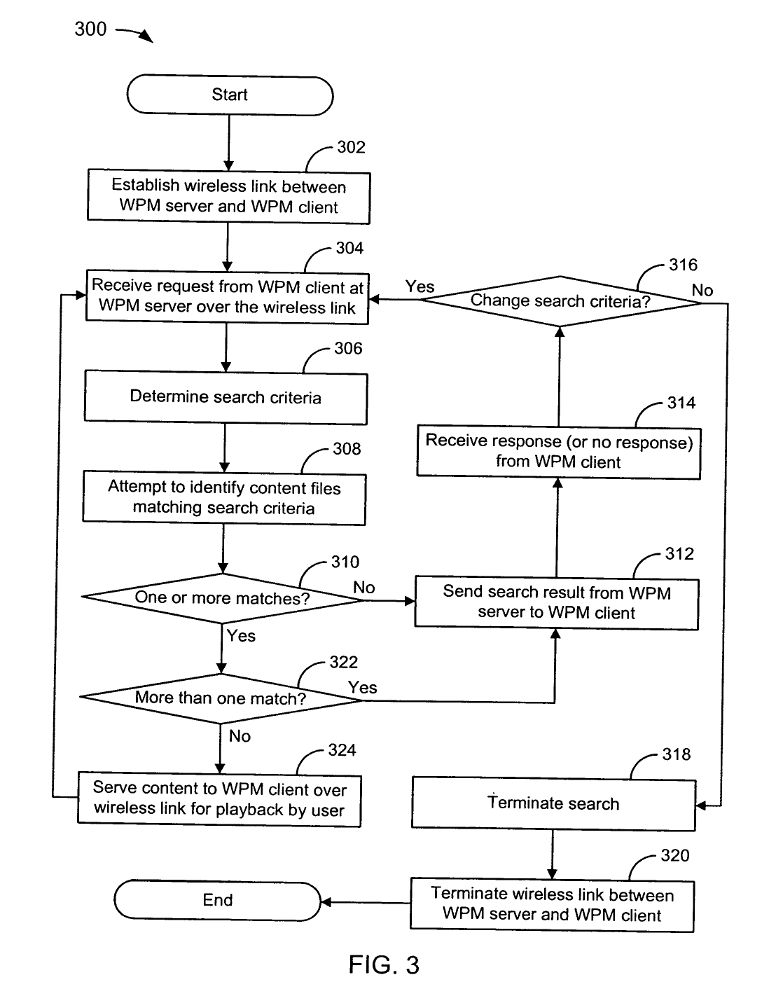

FIG. 3 depicts a flowchart 300 of an example of a method for providing content from a WPM server to a WPM client. This method and other methods are depicted as serially arranged modules. However, modules of the methods may be reordered, or arranged for parallel execution as appropriate. In the example of FIG. 3, the flowchart 300 begins at module 302 where a wireless link is established between a WPM server and a WPM client. In the example of FIG. 3, the flowchart 300 continues to module 304 where a request is received from the WPM client at the WPM server over the wireless link.

In the example of FIG. 3, the flowchart 300 continues to module 306 where search criteria are determined. The search criteria may be found in the request from the WPM client, or may be generated using some of the data in the request. In the example of FIG. 3, the flowchart 300 continues to module 308 where an attempt is made to identify content files matching search criteria.

In the example of FIG. 3, the flowchart 300 continues to decision point 310 where it is determined whether one or more matches are found. Matches occur when the search criteria identify one or more content files in a content database. If it is determined that there are no matches (310-N), then the flowchart 300 continues to decision point 312 where search results are sent from the WPM server to the WPM client. The WPM server may also send a query that prompts a user to perform some action (e.g., request different content or upload the content so it can be provided to the WPM client).

In the example of FIG. 3, the flowchart 300 continues to module 314 where a response (or no response) is received from the WPM client. When a response is received (or after an implementation-specific period of time spent waiting for a response), the flowchart 300 continues to decision point 316 where it is determined whether a response received from the WPM client changes the search criteria. If no response is received, that is similar to receiving a response that does not change the search criteria. If a response is received that changes the search criteria, the flowchart 300 continues to module 304 and proceeds as described above. If, on the other hand, a response is received that does not change the search criteria (or no response is received), the flowchart 300 continues to module 318 where the search is terminated, to module 320 where the wireless link between the WPM server and the WPM client is terminated, and the flowchart 300 ends.

Returning once again to decision point 310, if it is determined that one or more matches are found (310-Y), then the flowchart 300 continues to decision point 322, where it is determined whether more than one match is found. If it is determined that more than one match is found (322-Y), then the flowchart 300 continues to module 312 and the flowchart 300 proceeds as described previously. If, on the other hand, it is determined that more than one match is not found (322-N), then the flowchart continues to module 324 where the matched content is served to the WPM client over the wireless link for playback by a user. Having found a unique content match, the flowchart 300 continues to module 304 for receipt of another request (presumably after the content match plays to exhaustion, or the user decides to make a new request).

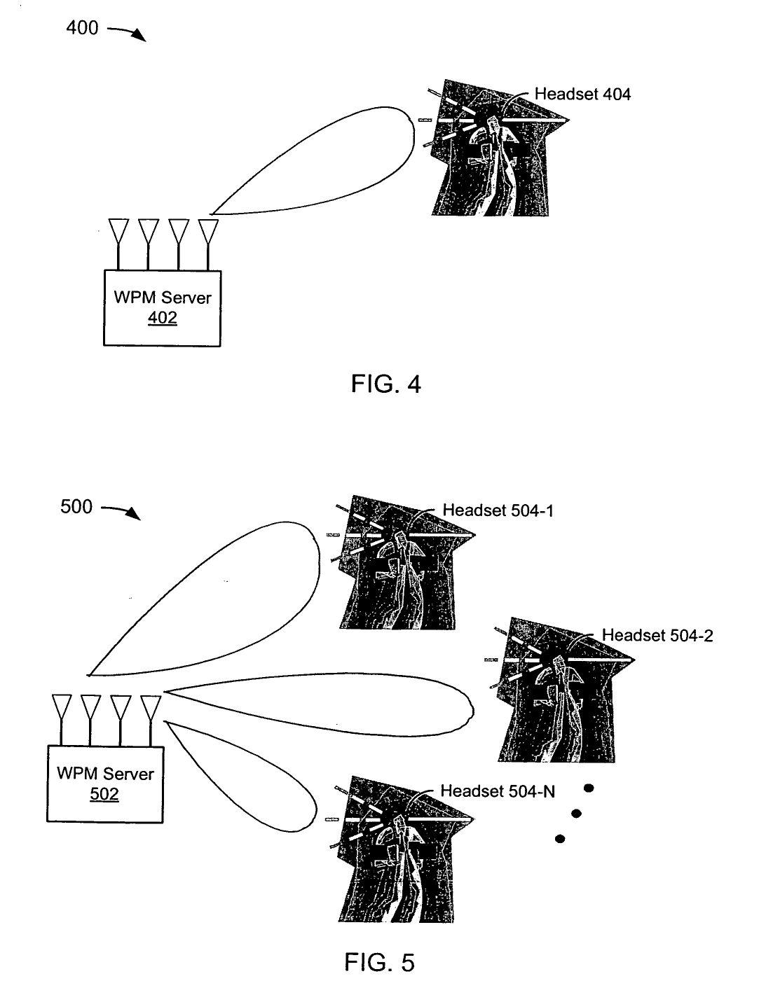

FIG. 4 depicts an example of a system 400 for providing music from a WPM server to a single WPM client. In the example of FIG. 4, the system 400 includes a WPM server 402 and a WPM client, which in this example is a headset 404. For illustrative purposes, a user of the headset 404 makes requests across a wireless link to the WPM server 402 for music files. The headset 404 may include a microphone for providing voice requests to the WPM server 402 and/or may include other input mechanisms, such as buttons or dials that can be operated to generate a request.

Presumably, if voice requests are allowed, the WPM server 402 includes a voice recognition engine capable of determining search criteria for a music file from the voice input from the headset 404. For example, a user may say a command to the headset 404 to initiate a music search request within one or more accessible music libraries on the WPM server 402, then say a search criteria by which these libraries should be searched. Alternatively, the voice recognition engine could be on or coupled to the headset 404.

When a search request is processed by the headset 404, the headset 404 initiates a music request process by establishing a wireless connection with the WPM server 402. When either the WPM server 402 or the headset 404 have multiple antennas, part of the process of establishing the wireless connection includes the WPM server 402 and the headset 404 jointly determining the best use of these antennas (e.g., diversity combining, beamforming, and/or multiplexing) to optimize the signal's range and quality relative to the wireless propagation conditions, the number of other users/devices accessing the WPM server 402, and the amount of interference in the band where the system is operating.

Once the wireless connection between the headset 404 and WPM server 402 is established, the search criteria by which the music library of the WPM server 402 is to be searched is sent by the headset 404 over this connection. Searching software on the WPM server 402 is used to identify the music file or music files desired by the user based on the search criteria. If only one music file is identified, then the music file may be streamed over the wireless connection to the headset 404 to be played for the user. The streaming may be preceded by an exchange over the wireless connection confirming with the user that the identified music file is the one desired. If more than one music file is identified by the WPM server 402, then the user could be queried via the wireless connection to the headset 404 which of the candidate music files is desired. When a music file is uniquely identified, the music file is streamed over the wireless connection. If no music files are identified for given search criteria, the user may be queried to expand the search criteria so as to identify additional candidate music files.

Once streaming of the music file begins, additional commands associated with the streaming, such as rewind, fast-forward, replay, pause, stop, etc., may be sent by the user via the headset to the WPM server 402. The streaming of music over the wireless connection may be optimized for quality by exploiting flexibility in the link and multiple access (MAC) layers of the wireless system design. For example, modulation, coding, antenna use, transmit power, and the retransmission protocol, as well as other link and MAC parameters and protocols, may be optimized for music streaming and its associated delay constraint. This optimization may utilize Quality-of-Service (QoS) capabilities in the wireless system, for example the IEEE 802.11e standard for wireless systems operating under one of the IEEE 802.11 standards. Some examples of this optimization include: optimizing the choice of constellation size (modulation) and code rate to maximize throughput given underlying channel conditions; optimizing antenna assignment and use for diversity combining, beamforming, and/or multiplexing to maximize throughput given underlying channel conditions; assigning high priority to retransmission of packets via for example some combination of priority queuing, antenna grouping/use, transmit power increase, and increased code rate; assigning high priority to packets based on their delay constraints via for example some combination of priority queuing, antenna grouping/use, transmit power increase, and increased code rate.

FIG. 5 depicts an example of a system 500 for providing music from a WPM server to multiple WPM clients. In the example of FIG. 5, the system 500 includes a WPM server 502 and multiple WPM clients, which in this example, are headsets 504-1 to 504-N (referred to collectively as headsets 504). FIG. 5 is intended to illustrate content sharing by users of one or more of the headsets 504. The same commands available to a single user during streaming (rewind, etc.) are also available to each user of the headsets 504, such commands are sent over the individual channels between the headsets 504 and the WPM server 502.

In an embodiment, the WPM server 502 has multiple independent wireless channels (in space, time, and/or frequency) over which it can communicate, hence independent wireless links are set up with each user over which music requests are processed. The multiple channels may be associated with a given multiuser wireless system or protocol (e.g. one of the IEEE 802.11b/g/a/n protocols or the IEEE 802.15 (Bluetooth/UWB/Zigbee) protocols) or it may span multiple systems or protocols (e.g. 802.11b/g/n and/or 802.15 at 2.4 GHz and 802.11a/n at 5 GHz). In the case of multiple users, the multiple antennas at the WPMS and/or headset may be used for beamsteering to reduce interference between users or to create independent spatial channels. The method for using the multiple antennas may utilize protocols within a standard for multiple access systems with multiple antennas, for example the 802.11n wireless standard.

In the example of FIG. 5, users of the headsets 504 may wish to access the same music file (music sharing) or different music files. For users who access different music files, either in shared or independent libraries of the WPM server 502, each user is treated in a manner similar to that described with reference to FIG. 4. In an embodiment, each of the headsets 504 may send separate music search requests to the WPM server 502.

In an embodiment, in order for multiple users to share music, they must first agree to share, which may include some process for authentication of the different headsets. This may be done by forming a direct wireless link between two or more headsets over which authentication and a share agreement is established, by a sharing feature on the WPM server 502 whereby multiple users establish a wireless connection with the WPM server 502, are authenticated, and can select other authenticated users with which to share music via this feature, or in some other manner.

Once the share agreement is in place, one of the users (say, User 1, associated with the headset 504-1) establishes a wireless connection with the WPM server 502 (this connection may already be in place if the share agreement is set up via the WPM server 502). The user then sends a request for a music file and the WPM server 502 honors the request in any convenient manner (see, e.g., FIG. 3) to identify a music file to be shared.

Once the music file is identified, the WPM server 502 establishes a wireless connection with headsets of users with which the music file is to be shared (including the headset 504-2, which is associated with User 2). (This connection may already be in place if the share agreement is set up via the WPM server 502). Once connections with the headsets 504-1 and 504-2 have been established, the music file to be shared is broadcast simultaneously to the headsets 504-1 and 504-2, via either independent channels or a common “music share” channel. Using a common channel saves system bandwidth. When independent channels are set up, each individual user can send streaming commands such as rewind, etc., to the WPM server 502. When the music is broadcast over the same channel, different protocols for streaming commands may be used. For example, the system may enable only one user to send commands, or all users can send commands (with or without override privileges for one of the users). In the scenario where multiple users access music on the WPM server 502, there may be a prioritization mechanism that assigns priorities to users and/or groups of users. This prioritization may impact channel assignment, transmission and/or retransmission priority, antenna use, transmit power, and any other parameter in the link or MAC protocol layers that impacts the end-to-end quality of the music streaming for each user.

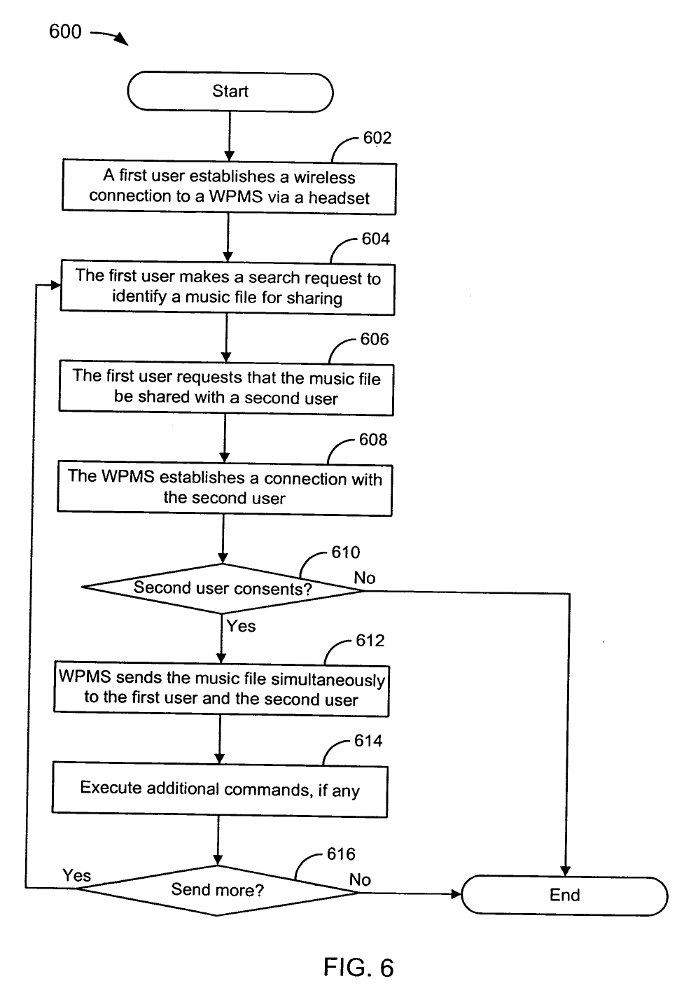

FIG. 6 depicts a flowchart 600 of an example of a method for music sharing in a WPM environment. In the example of FIG. 6, the flowchart 600 starts at module 602 where a first user establishes a wireless connection to a WPMS via a headset. In the example of FIG. 6, the flowchart 600 continues to module 604 where the first user makes a search request to identify a music file for sharing. In the example of FIG. 6, the flowchart 600 continues to module 606 where the first user requests that the music file be shared with a second user. In the example of FIG. 6, the flowchart 600 continues to module 608 where the WPMS establishes a connection with the second user.

In the example of FIG. 6, the flowchart 600 continues to decision point 610 where it is determined whether the second user consents to the sharing of the music file. If it is determined that the second user does not consent (610-N), then the flowchart 600 ends. If, on the other hand, it is determined that the second user consents (610-Y), then the flowchart 600 continues to module 612 where the WPMS sends the music file simultaneously to the first user and the second user. It should be noted that if the first user wishes to share a music file with multiple users, then the flowchart 600 would continue from module 612 for each user that consents (610-Y).

In the example of FIG. 6, the flowchart 600 continues to module 614 where additional commands are executed, if any. These commands may include pause, rewind, etc. Depending upon the implementation, the commands may be sent by the first user, the second user, or both users. In the example of FIG. 6, the flowchart 600 continues to decision point 616 where it is determined whether to send more music files. If no more music files are to be sent (616-N), then the flowchart 600 ends. If, on the other hand, more music files are to be sent (616-Y), then the flowchart 600 continues to module 604 and the flowchart 600 proceeds as described previously.

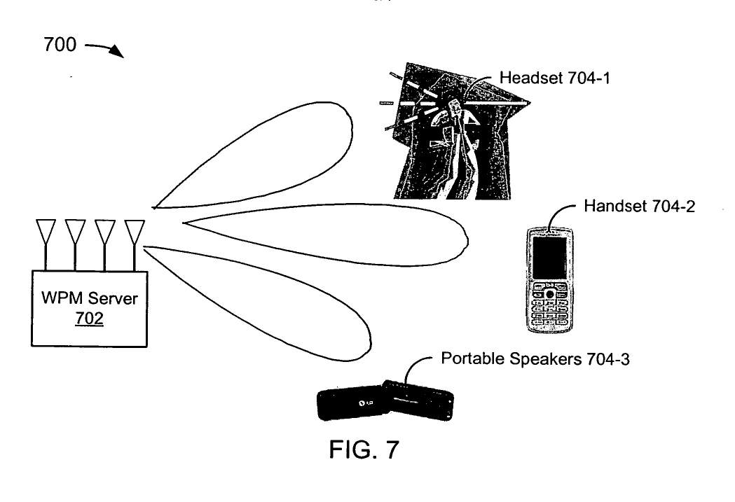

FIG. 7 depicts an example of a system 700 that includes various WPM clients in a WPM environment. FIG. 7 is intended to emphasize the fact that the WPM clients can be any of a variety of WPM clients. For example, the system 700 includes a headset 704-1, a handset 704-2, and a portable speaker system 704-3 (referred to collectively as WPM clients 704). Certain of the WPM clients 704 may be limited in the type of content they can play (e.g., portable speakers may not be able to play video or software application content, while handsets may be able to play most types of content, including software applications, if the content is properly configured). A content sharing feature, similar to the music sharing feature described with reference to FIG. 6, can be used with appropriate WPM clients 704.

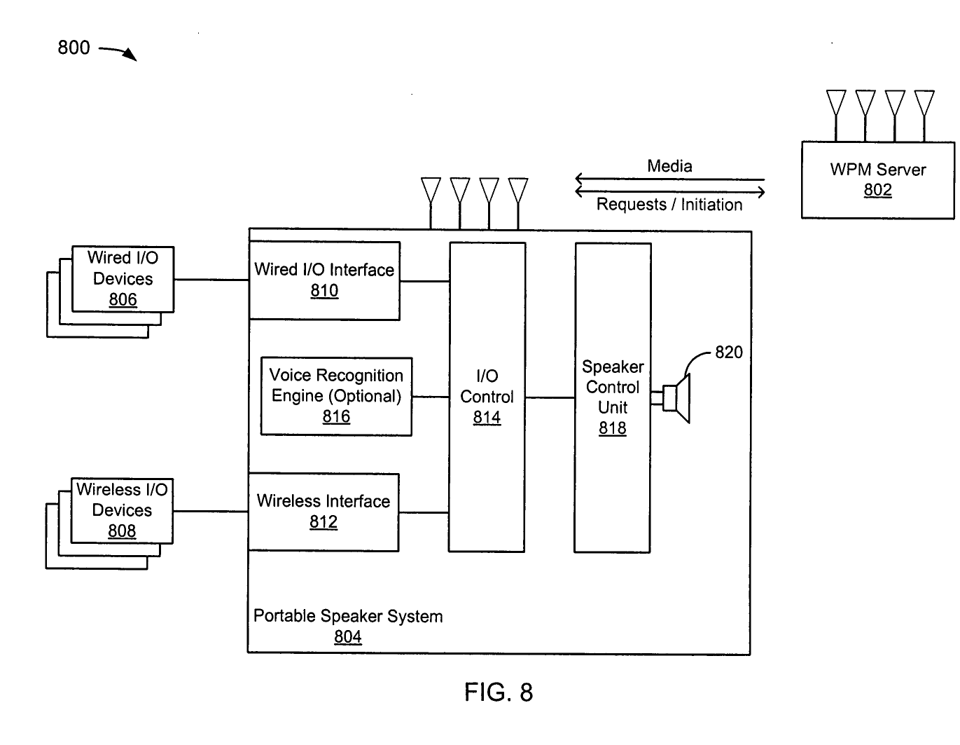

Audio file requests can be provided to the portable speaker system 704-3 in a manner similar to that described with reference to FIGS. 4 and 5 to headsets. However, for the portable speaker system 704-3, the method by which audio file search requests are initiated may be different. In particular, the audio file search request may be initiated by the portable speaker system 703-3 or it may be initiated by the WPM server 702. An example of this functionality is described with reference to FIG. 8.

FIG. 8 depicts an example of a portable speaker system 800 in a WPM environment. In the example of FIG. 8, the system 800 includes a WPM server 802, a portable speaker system 804, wired I/O devices 806, and wireless I/O devices 808. The portable speaker system 804 includes a wired I/O interface 810, a wireless interface 812, I/O control 814, an optional voice recognition engine 816, a speaker control unit 818, and a speaker 820. The voice recognition engine 816 may be used to translate voice commands into search criteria or other commands. Otherwise, commands and search criteria may be entered via wired or wireless input devices. Depending upon the embodiment and implementation, the portable speaker system may be capable of initiating a wireless link with the WPM server 802, and requesting content. Alternatively, depending upon the embodiment and implementation, the WPM server 802 may initiate the wireless link and send content without receiving a request from the portable speaker system 804. Alternatively, a WPM client or other device may send a request for playback on the portable speaker system 804 (this may be similar to a shared request where the requested file is only sent to the portable speaker system 804).

As used herein, the term “embodiment” means an embodiment that serves to illustrate by way of example but not limitation.

It may be noted that in examples of content that include only music files, the music files are streamed. However, in alternative embodiments, music files could be downloaded and then played. The advantage of streaming is that a playback device can begin to play a music file before the music file has been received in its entirety. The same is true for multimedia streaming and software streaming.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A method comprising:
creating a content library that is accessible to a wireless portable media (WPM) server;
establishing a wireless link between the WPM server and one or more WPM clients;
receiving at the WPM server a request for content, wherein the request is associated with the one or more WPM clients;
searching the content library for content that matches the request;
sending the content via the wireless link to the one or more WPM clients.

2. The method of claim 1, further comprising receiving additional commands selected from the group consisting of rewind, fast forward, replay, pause, stop, wherein the additional commands effect the sending of the content in accordance with the command.

3. The method of claim 1, wherein the wireless link follows a standard selected from the group consisting of 802.11a, 802.11b, 802.11g, 802.11n, 802.15.

4. The method of claim 1, further comprising using multiple antennae to optimize system performance based on wireless channel conditions and the number of users accessing the WPM server through a technique selected from the group consisting of diversity combining, beamforming, spatial multiplexing, a combination thereof.

5. The method of claim 1, further comprising streaming the content via the wireless link using end-to-end quality optimization by exploiting flexibility in the wireless link and MAC layers.

6. The method of claim 1, further comprising streaming the content via the wireless link using end-to-end quality optimization using quality of service (QoS) capabilities associated with a standard associated with the wireless link.

7. The method of claim 1, wherein the wireless link is in accordance with one of the IEEE 802.11 standards, further comprising using quality of service (QoS) capabilities of IEEE.11e standards.

8. The method of claim 1, further comprising:
receiving a request to share content among the one or more WPM clients;
broadcasting content associated with the request to the one or more WPM clients simultaneously over independent channels.

9. The method of claim 1, wherein the content is stored in the content library in one or more independent libraries associated with the one or more WPM clients.

10. The method of claim 1, wherein the content is stored in the content library in a shared library.

11. The method of claim 1, further comprising storing multiple file sizes for a content file, wherein searching the content library includes:
considering conditions associated with a WPM client of the one or more WPM clients;
selecting a file size that is appropriate for transmission to the WPM client based upon the consideration of conditions.

12. The method of claim 1, further comprising coupling the WPM server to an automobile.

13. A system comprising:
a plurality of wireless devices;
a wireless content server, including:
an interface coupled to the plurality of wireless devices;
a content server engine embodied in a computer-readable medium, coupled to the interface;
a database interface coupled to the content provisioning engine and the content server engine;
a content database coupled to the database interface,
wherein, in operation, requests for content from a wireless device of the plurality of wireless devices is received at the interface, the content server engine determines whether content uniquely identified in association with the request is stored in the content database, and the uniquely identified content is provided from the content database through the database interface and the content server engine to the interface for sending to the plurality of wireless devices.

14. The system of claim 13, further comprising:
a content provider coupled to the interface of the wireless content server;
a content provisioning engine embodied in a computer-readable medium, coupled to the interface;
wherein, in operation, content from the content provider is received at the interface, the content provisioning engine determines whether to store the content in the content database, and, if the content is to be stored, the content is provided to the database interface for storage in the content database.

15. The system of claim 13, wherein the content database includes flash memory.

16. The system of claim 13, wherein the wireless content server includes multiple antennae.

17. The system of claim 13, wherein a wireless device of the plurality of wireless devices includes a headset.

18. The system of claim 13, wherein a wireless device of the plurality of wireless devices includes a portable speaker system.

19. The system of claim 13, wherein a wireless device of the plurality of wireless devices includes a handset.

20. A system comprising:
a wireless portable media (WPM) server;
one or more WPM clients wirelessly coupled to the WPM server;
a means for receiving at the WPM server content from a content provider;
a means for wirelessly providing the content from the WPM server to the one or more WPM clients.
